(19) United States
(12) Patent Application Publication
(10) Pub. No.: US 2003/0053775 A1
(43) Pub. Date: Mar. 20, 2003

(54) Optical fiber adapted for interfacing

(76) Inventors: Datong Chen, Fremont, CA (US); Charles D. Hoke, Menlo Park, CA (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 09/954,992

(22) Filed: Sep. 17, 2001

(51) Int. Cl. G02B 6/26; G02B 6/16

(52) U.S. Cl. 385/123; 385/28; 385/39

(57) ABSTRACT

An optical fiber apparatus and method of aligning a singlemode optical fiber reduce problems associated with power loss due to misalignment of the fiber at an interface. The method comprises providing an optical fiber with an expanded core portion that terminates in an interface end and aligning the interface end of the expanded core portion to an optical component. The optical fiber apparatus has an expanded core portion that has an expanded core radius at an interface end of the optical fiber. The expanded core may be incorporated into the entire length of the optical fiber or in a transition section of a fiber that also comprises a basic core portion having a basic core radius. Both the expanded and basic core radius support only a single optical mode for propagating a signal.

### TECHNICAL FIELD

The invention relates to optical waveguides and fiber optics. In particular, the invention relates to singlemode optical fibers and the alignment and/or coupling thereof.

### BACKGROUND ART

Optical fibers, also referred to as ‘fiber optics’, play an important and ever expanding role in modern digital and analog communication systems. Among other things, optical fibers can carry or transmit digital and/or analog signals modulated onto one or more optical carriers over relatively long distances with very little loss in signal power. In addition to low loss, optical fibers can also provide extraordinarily wide usable bandwidths. Useable bandwidths greater than 25,000 GHz are possible with optical fibers in some applications. The combination of the low loss and the high bandwidth afforded by optical fibers make them attractive for a wide variety of communication system applications including, but not limited to, long-distance telecommunications and high-speed digital networking.

An optical fiber is a dielectric waveguide that carries or guides a propagating electromagnetic wave having a free space wavelength in the optical range from about 0.8 to 1.8 μm. A basic optical fiber is illustrated in FIG. 1. The basic optical fiber, generally a long, thin, cylindrical structure, comprises an inner portion known as a ‘core’ 10 and an outer portion or shell known as ‘cladding’ 12. The cladding 12 surrounds the core 10. Additionally, often one or more layers of material are used to cover the cladding 12. These cladding cover layers 14 typically provide the cladding 12 and core 10 with protection from physical damage. The cladding cover layers 14 can also help to reduce loss of guided signal power in long-distance transmission applications, as well as provide additional structural strength to the fiber itself.

An optical signal or wave is guided along an optical fiber by virtue of a difference in a dielectric constant or index of refraction n₁ of a core 10 material and an index of refraction n₂ of a cladding 12 material. Typically, the core 10 material index of refraction n₁ is greater than the cladding index of refraction n₂. In simple terms, interaction between the electromagnetic fields of the optical wave and the dielectric materials of the core 10 and cladding 12 effectively confine a majority of the optical wave to a region of the fiber in the vicinity of the core 10. A thorough treatment of the waveguide properties of an optical fiber can be found in many basic electromagnetic and optical fiber textbooks as well as in Hicks et al, U.S. Pat. No. 3,157,726 incorporated herein by reference.

A transition between the core 10 index of refraction n₁ and the cladding index of refraction n₂, sometimes referred to as a refractive-index profile, may be either abrupt or gradual. Fibers having a refractive-index profile with an abrupt transition are called ‘step-index’ fibers while those having a refractive-index profile with a gradual transition are generally referred to as ‘graded-index’ fibers. In addition to step-index and graded-index profiles, some optical fibers have complex refractive-index profiles, the specific shape of which is intended to enhance one or more desirable propagation characteristics and/or suppress one or more undesirable characteristics of the optical signal. In other optical fibers, multiple layers of cladding 12, each layer having a different index of refraction, are used to enhance waveguide properties of the optical fiber (e.g., dispersion-flattened fibers).

As a general rule, optical fibers can be divided into two principal types based on how an optical signal propagates within the fiber. The two principal types are known as ‘multimode’ fibers and ‘singlemode’ fibers. Multimode fibers support multiple propagating modes while singlemode fibers support only a single propagating mode of the optical wave.

As used herein, a ‘mode’ is a configuration or pattern of electric and magnetic fields within a guiding structure such as the optical fiber. The modes supported by a given guiding structure are defined by solutions to Maxwell's Equations. The modes may be either propagating or non-propagating. Non-propagating modes are referred to as ‘evanescent’ modes. Whether a particular mode is a propagating mode or an evanescent mode is typically determined by a frequency of the electromagnetic wave and by one or more physical characteristics of the guiding structure. In an optical fiber, whether or not a given mode propagates is determined by a free space wavelength λ₀, the size of the core, the indices of refraction of the core 10 and cladding 12, and the relative difference between the indices of refraction of the core 10 and the cladding 12.

Multimode optical fibers are typified by a diameter of the core 10 that is relatively large compared to the free space wavelength λ₀ of the guided optical wave or signal. Typical core diameters of multimode fibers are on the order of 50 μm to 100 μm. Having such large core diameters, multimode fibers can be manufactured very cheaply. Moreover, the large core diameters tend to ease interfacing constraints resulting in further reductions in the relative cost of using multimode fibers in a communication system. However, multimode fibers suffer from relatively high intermodal dispersion as well as other forms of signal loss and distortion associated with multimodal signal transmission. The signal loss and distortion exhibited by multimode fibers result in a relatively limited distance-bandwidth product. As a result, even with the their attractive economics, multimode fibers tend to enjoy somewhat limited application especially where distance and/or bandwidth are crucial performance parameters for the optical guide.

In contrast to multimode optical fibers, singlemode optical fibers feature relatively small diameter cores, low or very low dispersion, very high distance/bandwidth products. The core diameter of a singlemode optical fiber is generally on the order of the free space optical wavelength λ₀ of the guided wave or guided signal. Typical core diameters for commercially available singlemode optical fibers range from 6 μm to 10 μm. While singlemode fibers tend to be more expensive to manufacture and use than multimode fibers, the low distortion and very high distance-bandwidth products of singlemode optical fibers have resulted in their widespread use for optical networking and long-distance telecommunications.

The core 10 and cladding 12 of an optical fiber are typically manufactured from dielectric materials having low dissipative loss at optical wavelengths. Dielectric materials utilized in optical fibers for communication systems include, but are not limited to, various polymeric materials, as well as fused quartz or silica glass (SiO₂). Singlemode optical fibers are most commonly fabricated from fused quartz or silica (SiO₂) through an extrusion process. Generally, highly pure silica is used to minimize optical loss. The indices of refraction of the core 10 and cladding 12 layers are adjusted before, during, and/or after extrusion by the introduction of minute, controlled amounts of an impurity such as an oxide of Boron, Titanium or Germanium. The introduction of controlled amounts of impurities into a material is referred to herein as ‘doping’ and the impurity ions are called a ‘dopant ions’ or simply referred to as a ‘dopant’. In a typical commercially available singlemode optical fiber, the index of refraction of the core 10 is approximately 1.48, while the cladding 12 has an index of refraction of around 1.46. Blankenship in U.S. Pat. No. 3,932,162 (incorporated herein by reference) gives an example of such an extrusion-based fiber optic manufacturing methodology.

In most cases with singlemode optical fibers, a minimum core diameter is established or determined by a physical size necessary to permit at least one mode, the single mode, to exist as a propagating mode. Likewise, a maximum diameter is set by a physical size that would allow more than the single mode to propagate. In practice however, preventing the propagation of more than one mode is only one limiting factor dictating an effective or practical maximum diameter for a useful singlemode fiber. A second important characteristic of the singlemode optical fiber is macrobending loss.

Macrobending loss is a tendency for an optical signal in an optical fiber to leak or escape from the fiber at bends along the length of the fiber resulting in increased transmission loss. Fortunately, macrobending loss tends to decrease as the diameter of the core decreases. Thus, as long as the core is larger than the minimum diameter, the smaller the core diameter, the lower will be the macrobending loss. An effective maximum core diameter that is acceptable for a given macrobending loss is a diameter that is closer to the minimum diameter than it is to the maximum diameter at which more than the single propagating mode is supported.

Singlemode optical fibers whose operation is based on the principles discussed herein rarely can be manufactured long enough to avoid at least some inter-fiber connections or interfaces. In addition, a fiber interface is almost always present at the input and/or output of optical components that make up an optical communications network or system. The interface between a pair of optical fibers or an optical fiber and an optical component can present a significant problem to the performance of a system in terms of power loss, cost and reliability. In particular, a significant source of signal power loss in an optical communications network can often be attributed to optical misalignments of the very small cores of singlemode fibers at the interfaces within the network.

A conventional solution to the problem of interfacing singlemode optical fibers is the use of precision connectors. Unfortunately, precision connectors can be cost prohibitive. In addition, using and maintaining the precise alignment necessitated by conventional singlemode optical fibers presents a significant problem for assembly of optical components with fiber optic interfaces and for field installation and repair of singlemode fiber optic networks.

Accordingly, there is a need for an approach to reducing power loss at an interface between a pair of singlemode optical fibers or between a singlemode optical fiber and an optical component. In particular it would be advantageous if such an approach could reduce alignment precision necessary to achieve a given, tolerable level of interface power loss. Such an approach may improve the economics of using singlemode fibers and would help solve a long-standing need in the area of singlemode optical fiber communications.

### SUMMARY OF THE INVENTION

The present invention provides a fiber that has a core diameter that is larger or expanded relative to the conventional core diameter of a singlemode optical fiber. While the core diameter is expanded, the present invention maintains the singlemode propagation characteristics of the singlemode fiber. The expanded core of the optical fiber of the present invention can be either along an entire length of the optical fiber or confined to a transition section or region at or adjacent to the fiber's end, namely the interface end. Accordingly, the present invention is a singlemode optical fiber apparatus and method of aligning singlemode optical fibers that provides a novel optical path for, and a novel method of, guiding light. In part, the method and apparatus of the present invention provide for easier fiber alignment when coupling an optical fiber to another optical fiber or to an optical component.

In one aspect of the present invention, an optical path for guiding light is provided. The optical path defines a plurality of optical modes for the light, including a first mode. The optical path comprises an optical fiber having a basic portion and an end portion. The basic portion is adjacent to one end of the end portion. An interface end for the fiber is provided at another end of the end portion that is opposite to the one end. The basic portion has a minimum core diameter while the end portion and the interface end have a maximum core diameter. The maximum core diameter is greater than the minimum core diameter. Both the minimum and the maximum core diameters support only the first mode as a propagating mode of the light and also exclude other modes from the plurality of optical modes from propagating, thereby maintaining ‘singlemode’ characteristics of the optical fiber.

In another aspect of the present invention, a method of guiding light in an optical guide is provided. The optical guide defines a plurality of optical modes, a first of the modes propagates the light in the optical guide. The method comprises guiding the light through a basic portion of an optical fiber, where the optical fiber has a minimum core diameter and a maximum core diameter. Both the minimum and the maximum core diameters support only the first propagating mode. The method further comprises guiding the light through an end portion of the optical fiber, wherein the end portion comprises the maximum core diameter.

In still another aspect of the present invention, a method of aligning a singlemode optical fiber to an optical component is provided. The singlemode fiber propagates light along a length of the fiber only in a first mode of a plurality of optical modes. The method of aligning comprises providing an optical fiber having an expanded core portion that terminates in an interface end. The expanded core portion and the interface end have an expanded core radius that is greater than any other core radius that supports only the first propagation mode but less than a threshold core radius that, when exceeded, supports another mode of the plurality to propagate. The method further comprises aligning the interface end of the optical fiber to the optical component.

In some embodiments, the step of providing comprises calculating parameters associated with an expanded core. The step of calculating preferably utilizes an expanded core radius that is chosen to meet some physical interface criteria, such as percent power loss associated with a given, expected misalignment. The step of providing further comprises applying the parameters to create the optical fiber.

In yet another aspect of the present invention, a singlemode optical fiber is provided. The singlemode fiber supports only a first optical mode from a plurality of optical modes for propagating an optical signal along a length of the fiber. The singlemode optical fiber comprises an expanded core portion that provides an interface end to the fiber. The expanded core portion and the interface end have an expanded core radius. The expanded core radius is greater than any other core radius that supports only the first mode for singlemode propagation of the optical signal but smaller than a threshold core radius that, if exceeded, supports a second mode of the plurality to propagate.

The expanded core portion may comprise an entire length of the optical fiber. Alternatively, the optical fiber may further comprise a basic core portion adjacent to one end of the expanded core portion that is opposite the interface end. The basic core portion comprises one of the ‘any other core radius’ that supports only the first mode. In either case, a relationship between the expanded core and the basic core radii provides that a difference between the threshold core radius and the expanded core radius is less than a difference between the expanded core radius and the basic core radius. Moreover, when both the basic core portion and expanded core portion are present, the expanded core portion may further comprises a transition from the basic core radius to the expanded core radius that can be either one or more transition steps or a gradually increasing transition having respective intermediate core radiuses. The respective intermediate core radiuses are greater than the basic core radius and less than the expanded core radius except at the interface end.

In some embodiments, the fiber comprises the basic core portion and the expanded core portion, where the expanded core portion comprises an interface component that is either permanently or removably attached to the fiber. The interface component provides the interface end having the expanded core radius. The interface component may also comprises any one of the above-mentioned transitions.

The present invention provides for easier fiber alignment than available to the user of conventional singlemode optical fibers. By increasing the diameter of the optical fiber core, the absolute accuracy of the alignment necessary to achieve a given percentage of power coupling is reduced compared to the conventional, small diameter singlemode core configuration. The present invention is particularly useful for coupling two singlemode fibers together end to end, wherein the diameter of each of the optical fiber cores is expanded in accordance with the present invention at least at the interface ends. Also, the present invention is applicable to coupling a singlemode fiber to an optical component, such as the electro-optical components in an optical communications network or system. Such optical components include, but are not limited to, optical signal sources, optical modulator, optical amplifiers, optical switches, and optical receiver/detectors. The optical signal sources include, but are not limited to, lasers, laser diodes, and light-emitting diodes. In short, the incorporation of the expanded core diameter greatly eases the mechanical constraints and tolerances associated with fiber alignment, in part, allowing for significant improvements in interface coupling efficiency with a concomitant decrease in the cost of optical connectors used to interface the optical fiber. Certain embodiments of the present invention have other advantages in addition to and in lieu of the advantages described hereinabove. These and other features and advantages of the invention are detailed below with reference to the following drawings.

### BRIEF DESCRIPTION OF THE DRAWINGS

The various features and advantages of the present invention may be more readily understood with reference to the following detailed description taken in conjunction with the accompanying drawings, where like reference numerals designate like structural elements, and in which:

FIG. 1 illustrates a cut-away view of an end of a conventional optical fiber.

FIG. 2A illustrates a cross sectional view along the length of two conventional optical fibers interfaced together illustrating an alignment mismatch.

FIG. 2B illustrates an exploded cross sectional view of the conventional optical fiber cores of FIG. 2A taken at the interface perpendicular to the fibers' length.

FIG. 3A illustrates a flow chart of a method of aligning a singlemode optical fiber to an optical component according to the present invention.

FIG. 3B illustrates a flow chart of a step of providing an optical fiber of the method of FIG. 3A.

FIG. 3C illustrates a flow chart of a method of guiding light in an optical guide of the present invention.

FIG. 4A illustrates a stepped transition interface end of a singlemode optical fiber apparatus according to one or more embodiments of the present invention.

FIG. 4B illustrates a stepped transition interface end having multiple steps of a singlemode optical fiber apparatus according to other embodiments of the present invention.

FIG. 4C illustrates a smooth transition interface end of a singlemode optical fiber apparatus according to other embodiments of the present invention.

FIG. 5 illustrates a cross sectional view taken along the length of a singlemode optical fiber apparatus in accordance with a preferred embodiment of the present invention.

FIG. 6A illustrates a cross sectional view taken along the length of two singlemode optical fibers of FIG. 5 in one or more embodiments of an optical path in accordance with the present invention.

FIG. 6B illustrates a cross sectional view taken along the length of two singlemode optical fibers of FIGS. 4A and 4B in other embodiments of an optical path in accordance with the present invention.

FIG. 6C illustrates an exploded cross sectional view of the cores of the optical fibers of FIGS. 6A and 6B taken at the interface perpendicular to the length of the fibers illustrating the effect of misalignment on the expanded core interface end of the present invention.

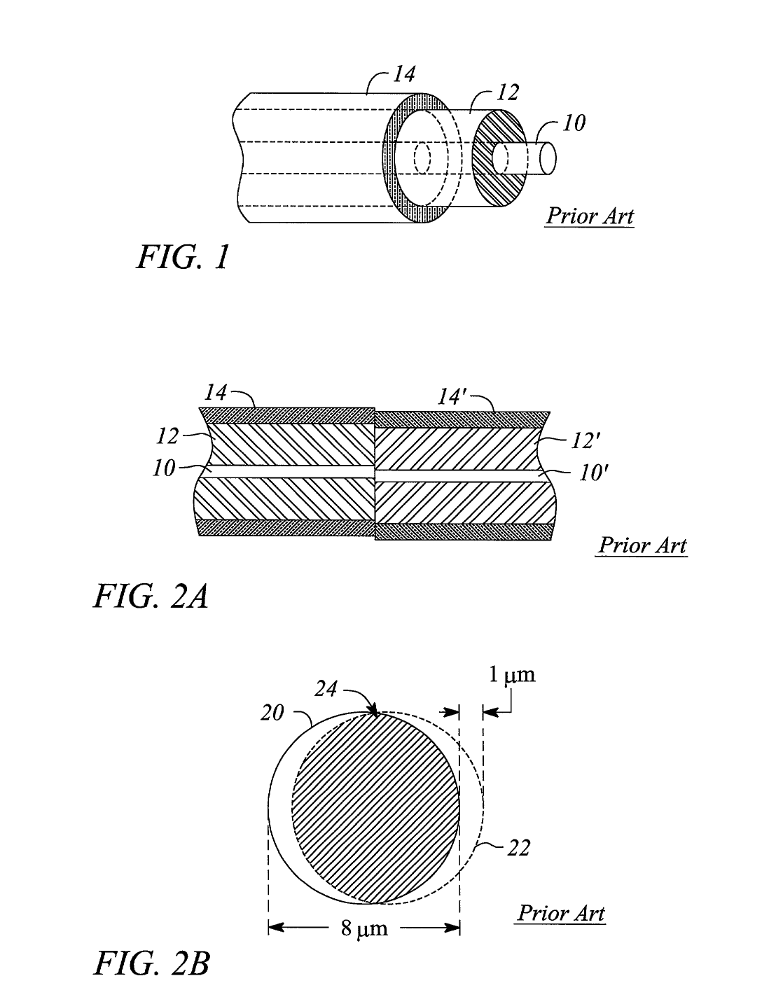

### MODES FOR CARRYING OUT THE INVENTION

The present invention provides a singlemode optical fiber apparatus and a method of aligning the optical fiber to an optical component that facilitate guiding light and provide an optical path for guiding the light. The method and apparatus of the present invention can decrease the effect of misalignment between interfaced guides in an optical path of the present invention while simultaneously preserving the singlemode propagation characteristics of the optical guide. The method and apparatus of the present invention facilitate potentially more cost effective and higher performance optical guide coupling.

Ideally at an interface between two optical guides, the entire signal (i.e. all of the signal power) transfers from one guide to the other. In practice, the interface always introduces some signal power loss. A chief cause of loss in such an interface is due to misalignments and physical mismatches between the guides on either side of the interface or between the guide and the component. The misalignment problem, primarily due to lateral misalignment of optical fiber cores on either side of the interface, is an especially critical problem for singlemode optical fibers due in large part to the comparatively small diameter of the fiber core. Since loss at the interface is related to the percentage overlap of the areas of the cores in a pair of fibers being coupled, even small misalignments can result in significant loss in signal power.

To better understand the present invention, consider an example of a misalignment between an interfaced pair of conventional singlemode optical fibers illustrated in FIG. 2A. A first fiber of the pair comprises a core 10, a cladding layer 12, and a protective sheath layer 14. A second fiber interfaced with a misalignment to the first fiber comprises a core 10′, a cladding layer 12′, and a protective sheath layer 14′. FIG. 2B illustrates a magnified cross-section taken across the interface of the cores 10, 10′ that shows the affect of the typical misalignment illustrated in FIG. 2A. The physical area of the core 10 of the first fiber is illustrated as circle 20 while the physical area of the core 10′ of the misaligned second fiber is illustrated as circle 22 in FIG. 2B. The crosshatched region 24 of FIG. 2B depicts the portion of the area of the fiber cores 10, 10′ that overlap at the interface.

For the purposes of discussion, assume that the power of a signal in a singlemode optical fiber is confined to and relatively evenly distributed throughout the area of the cores 20, 22. With this assumption, the ratio of the area of the cross-hatch region 24 to the area of the core 20, 22 is approximately proportional to the percentage of the signal power that can cross or transfer from one fiber to the other at an interface. Now, consider an example where the pair of optical fibers is interfaced and each fiber has a conventional core diameter of 8 μm. Furthermore, assume that at the interface, the cores 10, 10′ (areas 20, 22) are misaligned by 1 μm, as illustrated in FIG. 2B. The overlap area 24 of the cores 10, 10′ and therefore the power transfer at the interface is reduced by about 15.9 % compared to a perfect alignment. In optical communication systems and optical networks, the need to precisely align optical fibers at an interface can greatly increase the cost of the system. The alignment problem is only exacerbated by situations requiring that a pair of arrays of optical fibers be interfaced.

As noted above, a conventional singlemode optical fiber employs a core having a core diameter that is on the order of a free space wavelength λ₀ of an optical wave or signal to be guided by the fiber. As used herein, the free space wavelength λ₀ refers to a shortest wavelength of a signal being guided. Typical diameters of conventional singlemode optical fiber cores range from 6 μm to 10 μm. Thus, the radius of a conventional core typically is less than or equal to approximately 5 μm. Similarly, the conventional singlemode optical fiber has a cladding layer of around 125 μm although this thickness is less critical than the core diameter.

Advantageously, the core diameter of a singlemode fiber does not have to be on the order of the free space wavelength λ₀ of the optical signal to be guided. Instead, a maximum core diameter of the singlemode fiber for a given application actually can be determined by a cut-off frequency of a second or next higher propagating ‘mode’ of the guided signal, as is further described below.

Maxwell's Equations for a waveguide structure such as an optical fiber can be solved. Such a solution leads to the realization that guided electromagnetic waves propagate in such guiding structures in discrete ways known as ‘modes’. Each mode represents a discrete electromagnetic field configuration within the guide. Furthermore, the only modes that can propagate in a given waveguide, such as an optical fiber or guide, are those modes for which an optical frequency f₀=c/λ₀ is less than the cut-off frequency, where c is the speed of light. Thus, if the frequency f₀ of the guided signal is less than all cut-off frequencies, save one, then the signal can propagate in the one mode that is not cut-off. Or, to put it another way, the waveguide will operate as a singlemode guide.

For step-index optical fibers, the relationship between propagating mode cut-off frequency and a core radius a of the optical fiber can be given in terms of a cut-off number fₙₘ according to equation (1)

$${f}_{nm} \leq 2 π \frac{a}{{λ}_{0}} \sqrt{( {n}_{1}^{2} - {n}_{2}^{2} )} \qquad ( 1 )$$

where the subscripts n and m refer to an order or number of a given mode, λ₀ is the free space wavelength of the guided signal, n₁ is an index of refraction of the core, and n₂ is an index of refraction of the cladding. Thus, for a given wavelength λ₀, if equation (1) is satisfied for a given wave number fₙₘ, all modes with mode numbers equal to or less than the given mode number fₙₘ will be able to propagate.

For step-index optical fibers, the lowest order mode or dominant mode is the so-called HE₁₁ mode and the second or next higher order mode is the TE₀₁ mode, where ‘HE’ stands for hybrid electric and ‘TE’ stands for transverse electric. For singlemode step-index optical fibers, the cut-off number fₙₘ of interest is the cut-off number of the second or next higher order mode, namely TE₀₁ mode. The cut-off number fₙₘ for the TE₀₁ mode is f₁₀=2.405, as is given by Hicks, et al., U.S. Pat. No. 3,157,726, incorporated herein by reference. Thus, when the relationship of parameters a, λ₀, n₁, n₂ provided by the right hand side of equation (1) is less than or equal to the cut-off number f₁₀=2.405, the optical fiber will operate in as a singlemode waveguide.

Equation (1) can be rearranged with this ‘less than’ inequality in mind in a form of equation (2) that more easily relates the core radius a and the cut-off number f₁₀ of the next higher mode (i.e. the condition for singlemode operation).

$$a < {λ}_{0} \frac{2.405}{2 π \sqrt{( {n}_{1}^{2} - {n}_{2}^{2} )}} \qquad ( 2 )$$

Thus, according to equation (2) the core radius a of the fiber core for singlemode propagation is any value that is less than the relationship of parameters on the right hand side of equation (2). Moreover, given the index of refraction of the core n₁ and the index of refraction of the cladding n₂ and the free space wavelength λ₀ of the signal to be guided, a maximum core radius aₘₐₓ can be determined that still preserves the singlemode propagation. The maximum core radius aₘₐₓ (i.e., a ‘threshold core radius’) is simply the upper limit of the core radius a as given by equation (2), such that if exceeded, the core would support another optical mode to propagate in addition to the single, first mode.

An immediate result of considering equation (2) is the realization that singlemode propagation can exist for an infinitely large core radius a if the core and cladding have identical indices of refraction (i.e., n₁=n₂). One skilled in the art would recognize this as the propagation of a plane wave. A more subtle realization based on equation (2) is that a plane wave is not a guided wave, i.e., in the limit when n₂ becomes equal to n₁, the wave is no longer being guided. Therefore, as is well known in the art, the difference between the two refractive indices n₁, n₂ must be large enough to accommodate expected bends in the optical fiber without significant or at least unacceptable signal power loss.

Yet another rearrangement of equation (1) including the inequality of equation (2) yields equations (3a)-(3d). Equations (3a)-(3d) facilitate determining the index of refraction of the cladding n′₂ and/or the index of refraction of the core n′₁, given a predetermined value for an expanded core radius a′ and the guided signal free space wavelength λ₀.

$$Δ < {( {λ}_{0} \frac{2.405}{2 π {a}^{′}} )}^{2} \qquad \text{(3a)}$$

In equation (3a) a quantity Δ can be determined based on the values of the free space wavelength λ₀ and the expanded core radius a′. The quantity Δ is the difference of the squares of the core index of refraction n′₁ and the cladding index of refraction n′₂ as defined by equation (3b) where the apostrophes indicate that the indices of refraction are related to the expanded core radius a′.

Δ=n′₁²−n′₂² (3b)

Thus, for a given expanded core radius a′ and free space wavelength λ₀, as long as the difference Δ between the squares of the indices of refraction of the core and cladding is less than the right hand side of equation (3a), the optical fiber will operate as a singlemode optical fiber.

It is then possible to solve equation (3b) for either the core index of refraction n′₁ as in equation (3c) or the cladding index of refraction n′₂ as given by equation (3d).

n′₁=\sqrt{Δ+n′₂²} (3c)

n′₂=\sqrt{n′₁²−Δ} (3d)

The choice of whether to use equation (3b), equation (3c), or equation (3d) is determined by the application. The proper choice would be readily apparent to one skilled in the art without undue experimentation. The form of equations (3a)-(3d) are particularly useful to the invention, as will be described herein below.

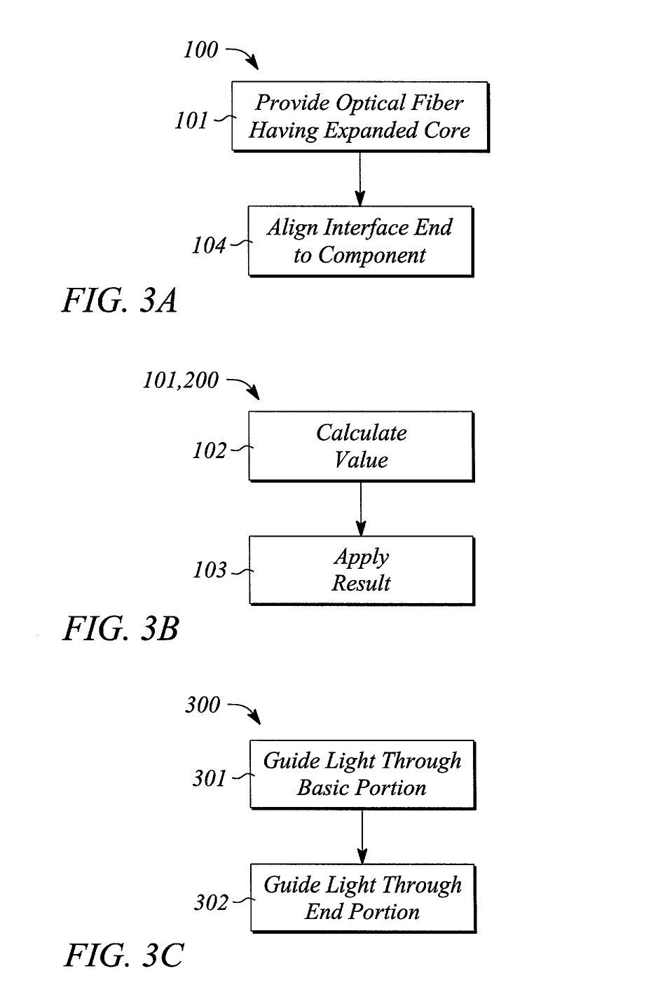

In one aspect of the invention, a method 100 of aligning a singlemode optical fiber to an optical component is provided. FIG. 3A illustrates a flow chart of the method 100. The method 100 comprises providing 101 an optical fiber having an expanded core portion that terminates in or is adjacent to an interface end. The expanded core portion and the interface end have an expanded core radius that is greater than any other core radius that supports only a first propagating mode but less than a threshold core radius that, if exceeded, supports another mode to propagate. The method further comprises aligning 104 the interface end of the optical fiber to the optical component. The ‘any other core radius that supports only a first propagating mode’ is the conventional core radius a, also referred to herein as the ‘basic’ core radius or the ‘minimum’ core radius (or ‘diameter’ 2a). According to the invention, a relationship between the expanded core radius and the ‘any other core radius’ is that a difference between the threshold core radius aₘₐₓ and the expanded core radius a′ is less than a difference between the expanded core radius a′ and the any other radius a (i.e., aₘₐₓ−a′<a′−a).

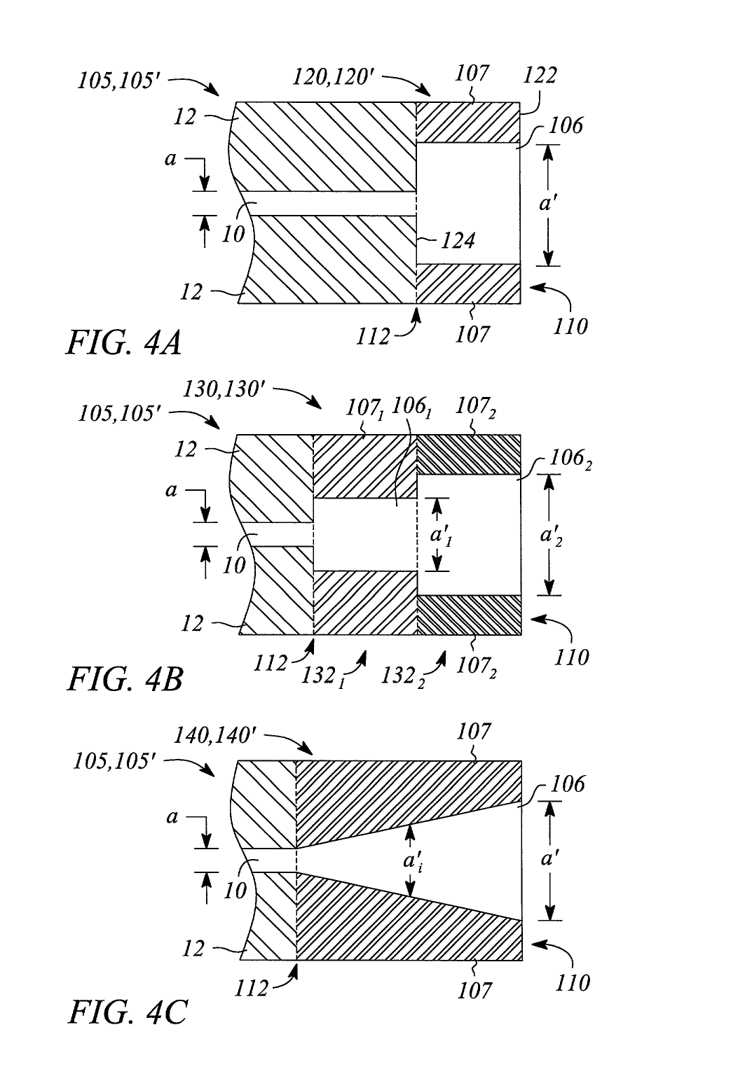

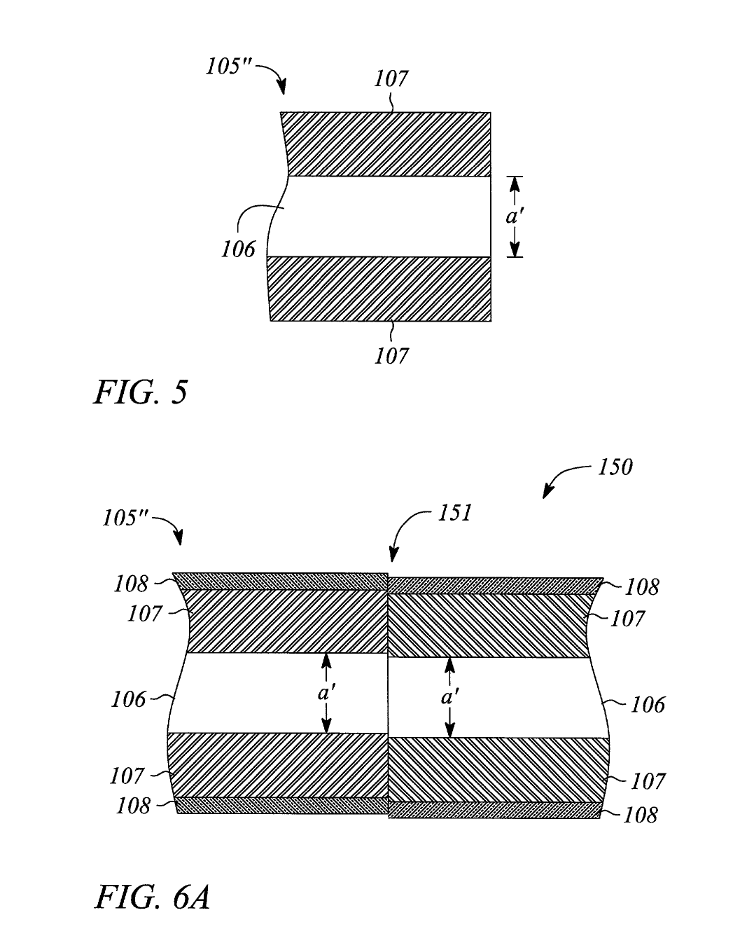

An optical fiber comprises a core having an index of refraction n₁ and a basic core radius a. The optical fiber further comprises a cladding having an index of refraction n₂. As illustrated in FIGS. 4A-4C and 5, the optical fiber apparatus 105, 105′, 105″ of the present invention comprises an expanded core portion having an expanded core radius a′, and depending on the embodiment, the expanded core index of refraction n′₁, the corresponding cladding index of refraction n′₂, and preferably, the expanded core radius a′ replaces the conventional or basic core radius a. The optical signal to be guided by the optical fiber comprises a free space wavelength λ₀. Preferably, the free space wavelength λ₀ is the reciprocal of a maximum frequency component of the guided signal. Any of the parameters n₁, n₂, a, n′₁, n′₂, and a′ may be either known or unknown values at the time that the step of providing 101 is implemented to create the singlemode optical fiber apparatus 105, 105′, 105″. Preferably, the basic core radius a and the expanded core radius a′ parameters are known.

FIG. 3B illustrates a flow chart of the step of providing 101 an optical fiber that supports a single propagation mode in accordance with the invention. The step of providing 101 comprises calculating 102 an unknown parameter value from known parameter values for the optical fiber using equations (3a) through (3d). Therefore, for a known and/or desired expanded core radius a′ value and a known free space wavelength λ₀, equations (3a) through (3d) can provide the numerical relationship between the expanded core index of refraction n′₁ and the cladding index of refraction n′₂ of the expanded core portion to achieve the desired expanded core radius a′.

The choice of a desired expanded core radius a′ value is one that provides acceptable alignment accuracy. However, the choice of the desired expanded core radius a′ value must generally be determined on a case-by-case basis, depending on the goal or improvement in alignment accuracy to be achieved. In general, the goal is to choose the desired expanded core radius a′ value, such that the optical fiber 105, 105′, 105″, comprising the desired expanded core radius a′, maintains a percentage power loss due to misalignment that is below a given level for an expected maximum misalignment.

Alternatively, if the expanded portion indices of refraction n′₁, n′₂ of the optical fiber 105, 105′, 105″ are known or given, then an expanded core radius a′ value can be determined from equation (2). The indices of refraction of the core and/or the cladding may be given where a particular core and/or cladding material is specified as necessary for the application. Other alternative combinations of known and unknown parameter n₁, n₂, a, n₁′, n₂′, a′, and λ₀ values for equations (3a)-(3d) are possible in accordance with the invention. One skilled in the art can readily determine the other combinations of knowns and unknowns, all of which are within the scope of the invention.

For example, assume for purposes of discussion only that the expected maximum lateral misalignment between an end of the optical fiber and another optical fiber is about 1 μm and the goal is to keep the loss due to misalignment power loss below about 3%. Elementary geometry yields a preferred expanded core diameter for this example of about 2a′=25 μm given that power loss due to misalignment is proportional to percent non-overlap of two circles representing the cores of the two optical fibers. Alternatively, in another example, the expanded core radius a′ may be given as a result of mechanical considerations of a connector for instance.

Continuing the example above, assume further for purposes of discussion only that a free space wavelength λ₀=1.3 μm is selected. Application of equation (3a) using a′=12.5 μm and λ₀=1.3 μm, yields that the difference Δ between the squares of the expanded portion indices of refraction must be less than a value Δₘₐₓ=0.03980783 for singlemode operation of the optical guide. Furthermore, again for the purposes of discussion only, suppose an expanded core refractive index n′₁ is given as n′₁=1.4800000, then equation (3d) can be used to compute the expanded portion cladding refractive index n′₂, which for this example would be n′₂=1.4664897. Alternatively, suppose a value for the expanded portion cladding index of refraction n′₂ is given as n′₂=1.4600000, then equation (3c) yields an expanded core index of refraction n′₁=1.4735697. Of course, these are limit values for the indices of refraction n′₁, n′₂. In practice, a value of the difference Δ slightly less than Δₘₐₓ would be used in equations (3c) and (3d) to find values of the expanded portion refractive indices n′₁, n′₂, thereby insuring that singlemode operation would be maintained in the expanded core optical fiber 105, 105′, 105″ of the present invention.

The step of providing 101 still further comprises applying 103 the known and the calculated parameters to the optical fiber. In one embodiment, the step of applying 103 applies the known and calculated parameters to the design or fabrication of the optical fiber. In this embodiment, at least a portion of the fiber's length, and preferably, the entire length of the optical fiber 105″, has a core 106 with the expanded core radius a′.

Where the method 100 is implemented to align 104 the ends of a pair of optical fibers together, preferably the known and calculated parameters would be applied 103 equally to both fibers of the pair so that the expanded core radii a′ match at the interface. At the very least, it is desirable that both optical fibers 105, 105′, 105″ of the pair have essentially the same expanded core radius a′ size at their respective interface ends. Where the method 100 is implemented to align 104 an optical fiber to an optical component, the step of applying 103 may be confined to the single optical fiber 105, 105′, 105″. The known and calculated parameters may be applied 103 to an optical guide component as well. According to the invention, the step of applying 103 comprises creating a transition section or region in the optical fiber in the vicinity of the end of the fiber to be interfaced. The transition region may comprise a portion of the optical fiber length (i.e., the expanded core portion or ‘end portion’), or preferably the transition region comprises the entire fiber length.

In one embodiment, the step of providing 101 creates an optical fiber 105 having the transition region in the expanded core portion of the optical fiber's length between an interface end 110 and a region boundary 112, such that the balance of the optical fiber length is outside of the transition region. The optical fiber 105 according to this embodiment is illustrated in FIGS. 4A-4C. Thus, the optical fiber 105 has a conventionally sized basic core radius a for most of its length (outside of the transition region) and has the expanded core radius a′ only in the transition region of the optical fiber 105 in the expanded core portion between the boundary 112 and the interface end 110.

Several transition region configurations are possible and within the scope of the step of providing 101. Three examples of transition region configurations for the optical fiber apparatus 105 of the present invention are illustrated in FIGS. 4A-4C. FIG. 4A illustrates a stepped transition 120 region. The stepped transition region 120 is a relatively short expanded core portion of optical fiber length that comprises the expanded core radius a′. A first end 122 of the stepped transition region 120 is at the interface end 110 of the optical fiber and a second end 124 is at the region boundary 112, where the stepped transition region 120 and the conventionally sized basic core portion 10 of the optical fiber 105 meet. With the stepped transition 120, there is an abrupt change in the core radius from the expanded core radius a′ to the conventional, basic core radius a of the optical fiber 105 at the boundary 112.

The stepped transition region 120 should be made long enough such that evanescent or non-propagating modes created by the abrupt core size change at the boundary 112 die out before reaching the interface end 110 (and vice versa, i.e., the non-propagating modes created by the abrupt core size change at interface end 110 die out before reaching the boundary 112). Preferably, the stepped transition region 120 should be at least several times the free space wavelength λ₀ of the guided optical signal to insure that only the optical wave having a single propagation mode can pass through the entire stepped transition region 120.

The stepped transition region 120 is created by applying 103 the known and calculated parameters to the design and fabrication of the optical fiber 105 within the transition region 120. In one embodiment, the same core material having an index of refraction n₁ is used for both the expanded core 106 in the transition region 120 and the core 10 in the balance of the optical fiber 105 adjacent the transition region 120, such that n′₁=n₁. The transition region 120 comprises the expanded core radius a′ and the balance of the optical fiber 105 comprises the basic core radius a. While the core index of refraction of the transition region 120 and that of the balance of the optical fiber 105 are essentially the same, the cladding 107 index of refraction in the transition region 120 is different from the cladding 12 in the balance of the fiber 105 (i.e. n′₂≠n₂). Instead, the cladding 107 index of refraction n′₂ is based on the results of the step of calculating 102, preferably using equation (3d).

Alternatively, the expanded core 106 index of refraction n′₁ in the stepped transition region 120 is modified based on the results of the step of calculating 102, preferably using equation (3c), such that it differs from the conventional core 10 index of refraction n₁ for the balance of the optical fiber 105 (i.e. n′₁≠n₁), and the cladding 107 index of refraction n′₂ is essentially the same as the cladding 12 index of refraction for n₂ the balance of the fiber (i.e., n′₂=n₂). A third alternative is that both the cladding 107 and the core 106 indices of refraction n′₁, n′₂ in the stepped transition region 120 differ from that of the balance of the optical fiber 105. The third alternative might preferentially utilize equation (3a) in the step of calculating 102 to define a difference Δ less than Δₘₐₓ between the refractive indices n′₁, n′₂ and leave the specific choice of index of refraction values to be made by a manufacturer.

A variation on the stepped transition 120 embodiment of FIG. 4A is the multiple stepped transition 130 region illustrated in FIG. 4B. The multiple stepped transition 130 comprises more than one stepped transition sections 132ₖ (k=1 . . . K) connected in series. Each of the stepped transition sections 132ₖ has a different expanded or intermediate core radius a′ₖ. Generally although not always, the expanded, intermediate core radius a′ₖ is increased in a stepwise manner from the boundary 112 to the interface end 110. Thus, for the example of the multiple stepped transition 130 illustrated in FIG. 4B having two stepped transition sections 132₁, 132₂, an expanded, intermediate core radius a′₁ of a first stepped section 132₁ would generally be less than an expanded, intermediate core radius a′₂ of a second stepped section 132₂. At the interface end 110 however, the expanded, intermediate core radius a′ₖ should equal the expanded core radius a′ (i.e., a₁<a₂<. . . aₖ, where aₖ=a′). All of the other discussion hereinabove regarding the alternatives for the stepped transition 120 embodiment applies equally to the multiple step transition 130 embodiment of the optical fiber 105 of the present invention.

Another transition region embodiment is the tapered transition 140 illustrated in FIG. 4C. The tapered transition 140 has an intermediate core radius aᵢ that changes gradually from the expanded core radius a′ at the interface end 110 to the conventional, basic core radius a the boundary 112. The taper can be linear, as illustrated in FIG. 4C, and/or non-linear (not illustrated). Generally, a smooth taper from the basic core radius a to the final expanded core radius a′ is preferred.

Each of the transition region configurations 120, 130, 140 is fabricated as an integral part of the optical fiber 105. The fiber 105 is fabricated using conventional methods and the transition region is simply integrally produced by these methods at the interface end of the optical fiber 105. However, in another aspect of the invention, the transition region configurations 120, 130, 140 are separate adaptors or transition elements 120′, 130′, 140′ that are attached to a conventional optical fiber for easier alignment when coupling. A conventional fiber that is modified in accordance with this aspect of the invention is an optical fiber apparatus 105′, as described further below with respect to method 200.

In the preferred embodiment, the step of applying 103 is applied to fabricate an optical fiber 105″ comprising the expanded core radius a′ along the entire length of the fiber 105″. Here also, the expanded core radius a′ is larger than the basic core radius a of a conventional optical fiber. FIG. 5 illustrates the optical fiber 105″ comprising an expanded core 106 having an expanded core radius a′ for the entire length of the fiber, and a cladding 107, in accordance with the present invention. The expanded core 106 has an expanded core index of refraction n′₁ and the corresponding cladding 107 has an index of refraction n′₂.

Referring again to the example above, the expanded core 106 of the optical fiber apparatus 105″ would have the expanded core radius a′=12.5 μm for the fiber's entire length to achieve a 3% power loss due to misalignment. This embodiment is preferred because it is relatively easier to fabricate a fiber with a constant core radius. However, the flexibility of the expanded core radius fiber 105″ may be diminished and bending losses may be increased in this preferred embodiment. One skilled in the art can readily look at the trade offs to decide which embodiment of the method 100 and apparatus 105, 105′ 105″ to use for a particular application.

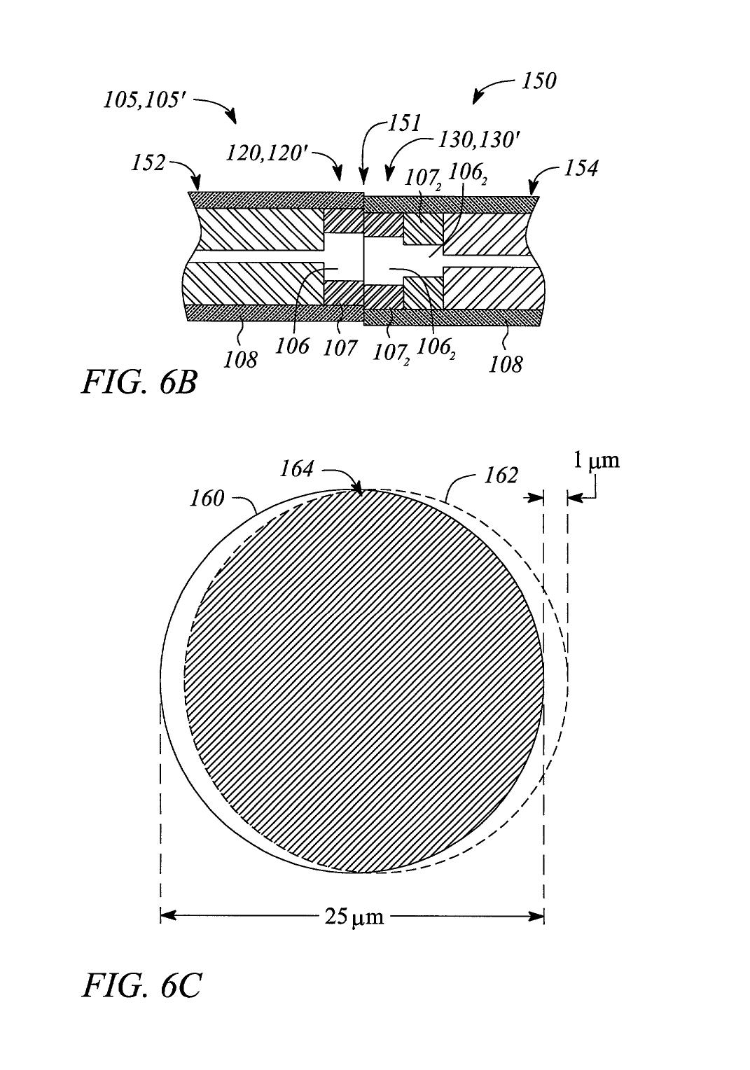

FIG. 6A illustrates an optical path 150 that comprises one or both of optical fibers 105″ in accordance with the preferred embodiment of the present invention on either side of an interface 151. Each fiber 105″ has an expanded core 106 with an index of refraction n₁′, an expanded core radius a′ for the entire length of the optical fiber 105″, a corresponding cladding 107 having an index of refraction n₂′ and a sheathing 108. The interfaced optical fibers 105″ are illustrated with a lateral misalignment at the interface 151, solely for the purpose described further below with respect to the example.

FIG. 6B illustrates an optical path 150 that comprises one or both of optical fibers 105, 105′ in accordance with the present invention on either side of an interface 151. Each fiber has a transition section at their respective interface ends. A first fiber 152 on the left hand side of the interface 151 is depicted with a stepped transition 120, 120′ configuration at the interface end 110. A second fiber 154 on the right hand side of the interface 151 is depicted with a 2-step, multiple stepped transition 130, 130′ configuration at its interface end 110. Each fiber has an expanded core 106 with an expanded core radius a′ at their respective interface ends, a corresponding cladding 107, and a sheathing 108. The optical fibers 152, 154 are illustrated with a lateral misalignment at the interface 151, similar to FIG. 6A and for the same purpose.

FIG. 6C illustrates a cross sectional view perpendicular to the fibers' length taken of the overlap area of the interface 151 of the optical path 150. A circle 160 represents an area of the expanded core of the first fiber 105″, 152 at the interface 151. A circle 162 (dashed line) represents an area of the expanded core of the second fiber 105″, 154 at the interface 151. The shaded area 164 represents an overlap area between the two, misaligned expanded cores 106. For the example hereinabove of an expanded core radius a′=12.5 μm, the mismatch power loss due to a 1 μm lateral misalignment at the interface 151 would be less than about 3%, as a result of the application of method 100 to provide the apparatus 105, 105′, 105″0 and the optical path 150 of the present invention. This compares very favorably to the example of a conventional core optical fiber having a basic core radius of 4 μm (i.e., core diameter of 8 μm) described hereinabove and illustrated in FIGS. 2A and 2B with a mismatch power loss of about 15.9% for a 1 μm lateral misalignment.

In another aspect of the present invention, a method 200 of creating an interface end in a singlemode optical fiber to facilitate alignment is provided. The method 200 is illustrated concurrently with the step of providing 101 in FIG. 3B and comprises calculating 102, which is the same as the step of calculating of method 100. The method 200 further comprises applying 103 the known and calculated parameters to the optical fiber. However, according to the method 200, the step of applying 103 is applied to modify an existing or conventional optical fiber having a basic core radius a, such that the modified optical fiber 105′ according to the present invention results. The step of applying 103 applies the parameters to create an interface component comprising a transition interface element 120′, 130′, 140′ having the expanded core radius a′ that is attached to an end of the optical fiber for coupling. The separate transition interface elements 120′, 130′, 140′ are similar to the transition regions 120, 130, 140, described above, except produced separately from the fabrication of the optical fiber. The separate elements 120′, 130′, 140′ are illustrated concurrently in FIGS. 4A-4C and 6B with transition regions 120, 130, 140.

In one embodiment, the conventional fiber is modified by permanently attaching (e.g., by welding, fusing, splicing or bonding) the created transition interface element 120′, 130′, 140′ to the end (adjacent boundary 112) of the conventional fiber to create the interface end 110 of the modified fiber 105′ according to the invention. By ‘permanently attaching’ it is meant that attempted detachment is likely to cause damage to the optical fiber 105′ or the interface element 120′, 130′, 140′. In another embodiment, the conventional fiber is modified by removably attaching the interface element 120′, 130′, 140′ to the end of the conventional optical fiber to create the modified fiber 105′ of the present invention. By ‘removably attaching’ it is meant that fastening devices, such as screws, clips, pins, adhesives (e.g., UV and the like releasable type adhesives), etc., are used for attachment, such that the interface element is readily detachable without expected damage. The separate transition region elements 120′, 130′, 140′are produced separately from, but preferably using similar methods and materials as the conventional methods and materials for fabricating, the optical fiber.

In all of the discussion herein, it assumed that one skilled in the art would be able to manufacture optical guides that have controlled indices of refraction and controlled core diameters. The manufacture of optical waveguides, such as optical fibers, is well known in the art. For example, Blankenship in U.S. Pat No. 3,932,162 (incorporated herein by reference) presents one such method of manufacturing optical fibers with controlled core diameters and indices of refraction.

In still another aspect of the present invention, a method 300 of guiding light in an optical guide is provided. The optical guide defines a plurality of optical modes including a first optical mode that propagates the light in the optical guide. FIG. 3C illustrates a flow chart of the method 300 of guiding light in an optical guide. The method comprises guiding 301 the light through a basic portion of an optical fiber. The optical fiber is one of optical fibers 105, 105′ that has both a minimum core diameter 2a and a maximum core diameter 2a′. The minimum and maximum core diameters both support only the first propagating mode. The method 300 further comprises guiding 302 the light through an end portion 120, 120′, 130, 130′, 140, 140′ of the optical fiber. The end portion of the optical fiber 105, 105′ has the maximum core diameter 2a′. The optical fiber 105, 105′ defines a threshold core diameter 2aₘₐₓ that, if exceeded, would result in at least one of the other optical modes being supported as another propagation mode. Further, a difference between the threshold core diameter and the maximum core diameter is less than a difference between the maximum core diameter and the minimum core diameter (i.e., 2aₘₐₓ−2a′<2a′−2a′).

In one embodiment, the method 300 further comprises guiding the light through an end portion of another optical fiber. Where the other optical fiber has both a minimum core diameter and a maximum core diameter, as in the first-mentioned optical fiber, the method further comprises guiding the light through a basic portion of the second-mentioned optical fiber. The steps of guiding can be performed in the listed order or in reverse order, such that each fiber can receive or transmit light from either of its basic portion and end portion. The double-headed arrow between the steps of guiding 301 and 302 in FIG. 3C illustrates that the light can travel in either direction through the fiber. In another embodiment, instead of another optical fiber, the method further comprises guiding the light through an optical component, which can be any one of another optical fiber, an optical signal source, an optical modulator, an optical amplifier, an optical switch, and an optical receiver/detector, for example.

The optical path 150 is illustrated in FIGS. 6A and 6B with respect to a pair of optical fibers (105″ and 105, 105′, respectively). However in the broadest sense, the optical path 150 of the present invention comprises a single optical fiber 105, 105′, 105″. In one embodiment, the optical path 150 comprises the optical fiber 105, 105′ having a basic portion and an end portion 120, 120′, 130, 130′, 140, 140′, which has the minimum core diameter 2a and the maximum core diameter 2a′, respectively. The basic portion and the end portion support a first optical mode from a plurality of optical modes as the only propagating mode of the light and exclude all other modes of the plurality from propagating. In one embodiment, the optical path 150 further comprises another optical fiber having an end portion 120, 120′, 130, 130′, 140, 140′. In another embodiment, the optical path 150 further comprises an optical component selected from one of the optical components listed above, for example.

Thus, there has been described a novel method 100 for aligning a singlemode optical fiber, a method 200 of creating an interface end in a singlemode optical fiber, a singlemode optical fiber apparatus 105, 105′, 105″, an optical path 150 and a method 300 of guiding light in an optical guide. It should be understood that the above-described embodiments are merely illustrative of the some of the many specific embodiments that represent the principles of the present invention. Clearly, those skilled in the art can readily devise numerous other arrangements without departing from the scope of the present invention as defined in the following claims.

What is claimed is:

1. An optical path for guiding light, the optical path defining a plurality of optical modes for the light including a first mode, the optical path comprising:
an optical fiber having a basic portion and an end portion, the basic portion being adjacent to one end of the end portion, another end of the end portion opposite the one end providing an interface end for the optical fiber, the basic portion having a minimum core diameter, the end portion having a maximum core diameter that is greater than the minimum core diameter, the basic portion and the end portion supporting the first mode as a propagating mode of the light and excluding others of the plurality of modes from propagating.

2. The optical path of claim 1, wherein the optical fiber defines a threshold core diameter that, if exceeded, results in at least one of the others of the modes being supported as another propagating mode, a difference between the threshold core diameter and the maximum core diameter being less than a difference between the maximum core diameter and the minimum core diameter.

3. The optical path of claim 1, further comprising a second optical fiber to the first-mentioned optical fiber, the second fiber having an end portion providing an interface end to the second optical fiber, the first optical fiber being connected to the second optical fiber with the respective interface ends opposed so that light exiting one of the interface ends enters the other of the interface ends.

4. The optical path of claim 3, wherein the end portion of the second optical fiber has a second maximum core diameter to the first-mentioned maximum core diameter and the second fiber further has a basic portion that is adjacent to one end of the end portion of the second fiber that is opposite the second fiber interface end, the basic portion of the second fiber having a second minimum diameter to the first-mentioned minimum core diameter, the second minimum core diameter being less than the second maximum diameter.

5. The optical path of claim 1, further comprising a source of the light.

6. The optical path of claim 1, wherein the end portion comprises a transition from the minimum core diameter to the maximum core diameter, the transition comprising at least one transition step, each transition step comprising an intermediate core diameter that is greater than the minimum core diameter and less than the maximum core diameter, each intermediate core diameter supporting only the first propagating mode.

7. The optical path of claim 1, wherein the end portion comprises a tapered transition having a gradually increasing intermediate core diameter from the minimum core diameter to the maximum core diameter, the increasing intermediate core diameter being greater than the minimum core diameter and less than the maximum core diameter, the intermediate core diameter gradually increasing one or both of linearly and nonlinearly, and wherein the increasing intermediate core diameter supporting only the first propagating mode.

8. The optical path of claim 1, wherein the end portion is an interface component having the maximum core diameter at the interface end, the interface component attaching to the basic portion at one end and providing the interface end for coupling at an opposite end, and wherein the interface component is one of permanently or removably attached to the end of the basic portion of the optical fiber.

9. The optical path of claim 1, wherein the interface component comprises a transition from the minimum core diameter to the maximum core diameter, the transition comprising at least one transition step, each transition step comprising an intermediate core diameter that is greater than the minimum core diameter and less than the maximum core diameter, each intermediate core diameter supporting only the first propagating mode.

10. The optical path of claim 1, wherein the interface component comprises a tapered transition having a gradually increasing intermediate core diameter from the minimum core diameter to the maximum core diameter, the increasing intermediate core diameter being greater than the minimum core diameter and less than the maximum core diameter, the intermediate core diameter gradually increasing one or both of linearly and nonlinearly, and wherein the increasing intermediate core diameter supporting only the first propagating mode.

11. The optical path of claim 1, further comprising an optical component, the optical component being one of another optical fiber, an optical signal source, an optical modulator, an optical amplifier, an optical switch, or an optical receiver/detector, wherein the interface end of the optical fiber is adjacent to the optical component so that a signal exiting one of the fiber or the optical component enters the other.

12. A method for guiding light in an optical guide, the optical guide defining a plurality of optical modes including a first optical mode that propagates the light in the optical guide, the method comprising:
guiding the light through a basic portion of an optical fiber, the optical fiber having a minimum core diameter and a maximum core diameter that both support only the first propagating mode; and
guiding the light through an end portion of the optical fiber, the fiber end portion having the maximum core diameter.

13. The method of claim 12, wherein the optical fiber defines a threshold core diameter that, if exceeded, results in at least one of the other optical modes being supported as another propagating mode, a difference between the threshold core diameter and the maximum core diameter being less than a difference between the maximum core diameter and the minimum core diameter.

14. The method of claim 12, further comprising:
guiding the light through an end portion of another optical fiber.

15. The method of claim 14, further comprising:
guiding the light through a basic portion of the second-mentioned optical fiber, the second optical fiber having a minimum core diameter and a maximum core diameter, the second fiber minimum core diameter and the second fiber maximum core diameter both supporting only the first propagating mode; the second fiber minimum core diameter being less than the second fiber maximum core diameter, the basic portion of the second fiber having the second fiber minimum diameter, the second fiber end portion having the second fiber maximum diameter.

16. The method of claims 15, wherein the steps are performed in the listed order or in reverse order.

17. The method of claim 12, further comprising:
guiding the light into an optical component.

18. The method of claim 12, wherein the end portion is an interface component having the maximum core diameter at an interface end, the interface component attaching to the basic portion at one end and providing the interface end for coupling at an opposite end, and wherein the interface component is one of permanently or removably attached to the end of the basic portion of the optical fiber.

19. The method of claim 18, further comprising coupling the optical fiber having the interface component at the interface end to an optical component selected from one of another optical fiber, an optical signal source, an optical modulator, an optical amplifier, an optical switch, or an optical receiver/detector, wherein the interface end of the interface component is adjacent to the optical component so that a signal exiting one of the fiber or the optical component enters the other.

20. The method of claim 12, wherein the end portion comprises a transition from the minimum core diameter to the maximum core diameter, the transition comprising at least one transition step, each transition step comprising an intermediate core diameter that is greater than the minimum core diameter and less than the maximum core diameter, each intermediate core diameter supporting only the first propagating mode.

21. The method of claim 12, wherein the end portion comprises a tapered transition having a gradually increasing intermediate core diameter from the minimum core diameter to the maximum core diameter, the increasing intermediate core diameter being greater than the minimum core diameter and less than the maximum core diameter, the intermediate core diameter gradually increasing one or both of linearly and nonlinearly, and wherein the increasing intermediate core diameter supporting only the first propagating mode.

22. A method of aligning a singlemode optical fiber to an optical component, the singlemode fiber for propagating light along a length of the fiber only in a first mode of a plurality of optical modes, the method comprising:
providing an optical fiber having an expanded core portion that terminates in an interface end, the expanded core portion and the interface end having an expanded core radius that is greater than any other core radius that supports only the first propagation mode but less than a threshold core radius that, if exceeded, supports another mode of the plurality of modes to propagate; and
aligning the interface end of the optical fiber to the optical component.

23. The method of claim 22, wherein the optical component is another optical fiber and the method further comprises:
providing the second-mentioned optical fiber having a second fiber expanded core portion that terminates in a second fiber interface end, the second fiber expanded core portion and the second fiber interface end having a second fiber expanded core radius that is greater than the any other core radius that supports only the first propagation mode but smaller than the threshold core radius; and
the step of aligning comprises aligning the interface ends of the respective fibers together.

24. The method of claim 22, wherein in the step of providing, the expanded core portion extends an entire length of the optical fiber.

25. The method of claim 22, wherein the optical fiber further has a basic core portion adjacent to an end of the expanded core portion that is opposite to the interface end, the basic core portion having a basic core radius equal to one of the any other core radius that supports only the first propagation mode, the basic core radius being less than the expanded core radius.

26. The method of claim 25, wherein the step of providing comprises creating a transition from the basic core radius to the expanded core radius in the expanded core portion, wherein the transition comprises one or more transitions steps, each transition step comprising an intermediate core radius, each intermediate core radius being greater than the basic core radius and less than the expanded core radius, and wherein each intermediate core radius supports only the first propagation mode.

27. The method of claim 25, wherein the step of providing comprises creating a tapered transition in the expanded core portion of the fiber, wherein the tapered transition comprises a gradually increasing intermediate core radius from the basic core radius to the expanded core radius, the gradually increasing intermediate core radius increasing one or both of linearly and nonlinearly, the increasing intermediate core radius being greater than the basic core radius and less than the expanded core radius, and wherein the increasing intermediate core radius supports only the first propagation mode.

28. The method of claim 22, wherein a difference between the threshold core radius and the expanded core radius is less than a difference between the expanded core radius and the any other core radius that supports only the first propagation mode.

29. The method of claim 22, wherein the step of providing comprises:
calculating parameters associated with an expanded core so that the optical fiber supports only the first propagating mode; and
applying the parameters to the optical fiber to create the expanded core portion using one or more of equations
$$Δ < {( {λ}_{0} \frac{2.405}{2 π {a}^{′}} )}^{2} , \qquad \text{(3a)}$$
Δ=n′₁²−n′₂² (3b),
n′₁=\sqrt{Δ+n′₂²} (3c),
and
n′₂=\sqrt{n′₁²−Δ} (3d),
where a′ is the expanded core radius relative to the any other core radius a that supports only the first propagation mode, λ₀ is a free space wavelength of the light to be guided by the optical fiber, n₁′ is an index of refraction of a core material of the expanded core, and n₂′ is an index of refraction of a cladding material surrounding the expanded core of the expanded core portion.

30. A singlemode optical fiber for guiding an optical signal only in a first propagation mode of a plurality of optical modes along a length of the optical fiber, the optical fiber having a core and a cladding surrounding the core and comprising:
an expanded core portion of the fiber providing an interface end to the fiber, the expanded core portion having an expanded core radius at the interface end, the expanded core radius being greater than any other core radius that supports only the first mode for singlemode propagation of the optical signal but smaller than a threshold core radius that, if exceeded, supports a second mode of the plurality to propagate.

31. The optical fiber of claim 30, wherein the expanded core portion comprises all of the optical fiber length.

32. The optical fiber of claim 30, further comprising a basic core portion having a basic core radius, the basic core radius being equal to one of the any other core radius that supports only the first propagation mode, wherein the basic core portion is adjacent to an end of the expanded core portion that is opposite to the interface end.

33. The optical fiber of claim 32, wherein the expanded core portion comprises one or more transitions steps, each transition step comprising an intermediate core radius, each intermediate core radius being greater than the basic core radius and less than the expanded core radius, each intermediate core radius supporting only the first propagation mode.

34. The optical fiber of claim 32, wherein the expanded core portion comprises a tapered transition having a gradually increasing intermediate core radius from the basic core radius to the expanded core radius, the gradually increasing intermediate core radius increasing one or both of linearly and nonlinearly, the increasing intermediate core radius being greater than the basic core radius and less than the expanded core radius, and wherein the increasing intermediate core radius supports only the first propagation mode.

35. The optical fiber of claim 32, wherein the expanded core portion is an interface component, the interface component being one of permanently or removably attached to an end of the basic core portion and providing the interface end for coupling the optical fiber.

36. The optical fiber of claim 35, wherein the interface component comprises a transition from the basic core radius to the expanded core radius, the transition comprising one or more transitions steps, each transition step comprising an intermediate core radius, each intermediate core radius being greater than the basic core radius and less than the expanded core radius, each intermediate core radius supporting only the first propagation mode.

37. The optical fiber of claim 35, wherein the interface component comprises a tapered transition having a gradually increasing intermediate core radius from the basic core radius to the expanded core radius, the gradually increasing intermediate core radius increasing one or both of linearly and nonlinearly, the increasing intermediate core radius being greater than the basic core radius and less than the expanded core radius, and wherein the increasing intermediate core radius supports only the first propagation mode.

38. The optical fiber of claim 30, wherein a difference between the threshold core radius and the expanded core radius is less than a difference between the expanded core radius and the any other core radius that supports only the single propagation mode.
